(19) United States
(12) Patent Application Publication
(10) Pub. No.: US 2004/0176868 A1
(43) Pub. Date: Sep. 9, 2004

(54) Remote maintenance system and remote maintenance method for semiconductor manufacturing apparatus

(76) Inventors: Naoyuki Haga, Tokyo (JP); Akira Machida, Aizuwakamatsu-shi (JP)

Correspondence Address: FINNEGAN, HENDERSON, FARABOW, GARRETT & DUNNER, LLP, 1300 I STREET, NW, WASHINGTON, DC, 20005, US

(21) Appl. No.: 10/475,997

(22) PCT Filed: Apr. 26, 2002
(86) PCT No.: PCT/JP02/04250

(30) Foreign Application Priority Data
Apr. 27, 2001 (JP) 2001-132814
May 15, 2001 (JP) 2001-145509

(51) Int. Cl. G06F 19/00

(52) U.S. Cl. 700/121; 700/117; 700/110; 700/108

(57) ABSTRACT

A factory-side client 100 at a factory where a semiconductor manufacturing apparatus is installed and a vendor-side server 200 at a vendor who executes maintenance management for semiconductor manufacturing apparatuses are connected to the Internet 300 which is a network enabling bidirectional communication and thus can exchange data with each other. The client 100 collects status information with regard to the apparatus and transmits the status information to the server 200. Based upon the status information, the server 200 executes a judgment as to whether or not an abnormality or a semi-abnormality has occurred in the apparatus, infers a probable cause and the corresponding corrective measures to be taken by conducting a search of the database in the event of an abnormality or a semi-abnormality and provides the client 100 with maintenance information and an instruction indicating the cause and corrective measures.

### TECHNICAL FIELD

The present invention relates to a remote maintenance system for a semiconductor manufacturing apparatus, a factory-side client and a vendor-side server ideal in an application in the remote maintenance system, a method and a program for executing remote maintenance on a semiconductor manufacturing apparatus and a storage medium having the program stored therein.

### BACKGROUND ART

Semiconductor devices are manufactured through various types of processing including an etching process, a film forming process, an ashing process and a sputtering process, executed by utilizing various semiconductor manufacturing apparatuses in correspondence to the individual processes. Examples of manufacturing apparatuses employed in semiconductor device production include the cluster-type multichamber manufacturing apparatus capable of executing different types of processing within a single apparatus. In this type of apparatus, a plurality of vacuum processing chambers are connected to a common transfer chamber. The transfer chamber is also connected with a delivery chamber via an auxiliary vacuum chamber having a load-lock function. Semiconductor wafers i.e., substrates undergoing the processing, are carried in/out through the delivery chamber. The use of such an apparatus is effective in achieving higher integration in semiconductor devices, higher throughput and also in preventing contamination of the workpiece.

The structure of the semiconductor manufacturing apparatus described above is bound to be complex. For this reason, once a failure occurs, the apparatus needs to be stopped over an extended period of time for repair. As a result, the throughput is lowered. In order to improve the yield of semiconductors obtained through the processing and assure a specific level of throughput, it is crucial that proper maintenance be executed on the apparatus.

However, in the typical maintenance service provided for semiconductor manufacturing apparatuses in the related art, specific corrective measures are taken in the event of a failure in an apparatus only after obtaining information on the problem via telephone, fax or the like. This gives rise to a problem in that since the vendor cannot accurately assess the exact state of the problem or the exact maintenance state of the apparatus at the customer side, the vendor is not able to provide the customer with appropriate instructions even if, for instance, there has been an error in the maintenance procedure performed at the customer side. In addition, since the vendor cannot obtain accurate information on the problem, it may take an unnecessarily long time to restore the apparatus. Namely, as an engineer dispatched by the apparatus vendor to repair the apparatus at the work site may have to leave for the work site without knowing the exact state of the problem and thus without carrying parts, tools and the like necessary for the repair work, the repair may become an unnecessarily time-consuming process. Since the vendor side cannot start the appropriate repair on the failed apparatus immediately, as described above, the operation rate of the apparatus becomes poor, resulting in lowered throughput.

An object of the present invention, which has been completed by addressing the problems discussed above, is to provide a remote maintenance system for a semiconductor manufacturing apparatus that makes it possible to provide a proper maintenance service promptly by accurately assessing the operating state, the state of failure in an apparatus, the state of the maintenance work on the apparatus executed at the customer-side even when the apparatus is used at a remote location, a factory-side client and a vendor-side server ideal in an application in the remote maintenance system, a method and a program for executing remote maintenance on a semiconductor manufacturing apparatus and a storage medium having the program stored therein.

### DISCLOSURE OF THE INVENTION

In order to achieve the object described above, a first aspect of the present invention provides a remote maintenance system for a semiconductor manufacturing apparatus, comprising a factory-side client operating at a factory where at least one semiconductor manufacturing apparatus is installed, a vendor-side server belonging to a manager who carries out maintenance management for the semiconductor manufacturing apparatus and a network that connects the factory-side client and the vendor-side server with each other so as to enable bidirectional communication. The remote maintenance system is characterized in that the factory-side client includes a data collection unit that collects status information with regard to the semiconductor manufacturing apparatus and a transmission/reception unit that transmits the status information having been collected to the vendor-side server via the network and receives information transmitted from the vendor-side server, and in that the vendor-side server includes a judgment unit that judges whether or not the semiconductor manufacturing apparatus corresponding to the status information manifests an abnormality or semi-abnormality based upon the status information, a database unit in which maintenance information with regard to the semiconductor manufacturing apparatus is stored in memory and a transmission/reception unit that receives the status information from the factory-side client and transmits information or an instruction to the factory-side client. Through this system, which enables bidirectional data transmission/reception between the factory-side client and the vendor-side server, it becomes possible to manage semiconductor manufacturing apparatuses at remote locations. In addition, in the event of an apparatus failure, the factor causing the failure can be identified accurately and quickly by making a judgment as to whether or not the apparatus has manifested abnormality or semi-abnormality based upon the status information and conducting a data search of the database unit having stored therein the maintenance information.

It is desirable that the status information include operating state information and apparatus information with regard to the semiconductor manufacturing apparatus. The operating state information refers to data related to the operating state of the apparatus. The apparatus information may contain, for instance, various logs such as a process log, a machine log and a trace log and data indicating particle check results, defects and yield.

In addition, it is desirable that the maintenance information include one type of or a plurality of types of information selected from an information group constituted of information indicating the causes of abnormalities and the corresponding corrective measures with regard to the semiconductor manufacturing apparatus, information indicating normal values of various parameters, information indicating the abnormality history, information indicating the part replacement history, information indicating the part inventory and information indicating the maintenance personnel schedules.

The judgment unit may be set so that it judges that an abnormality has occurred based upon the operating state information if the ratio of unscheduled downtime of the semiconductor manufacturing apparatus exceeds a predetermined ratio, if the length of unscheduled downtime of the semiconductor manufacturing apparatus exceeds a predetermined length of time or if the number of times that the semiconductor manufacturing apparatus has experienced unscheduled downtime within a specific period of time exceeds a predetermined value.

It is also desirable that the judgment unit be set so as to judge based upon the apparatus information that a semi-abnormality has occurred if the semiconductor manufacturing apparatus is in a state that does not induce a process down immediately but may lead to a process down as a long period of time elapses. By setting up the judgment unit in this manner, it is possible to take preventive action against a process down before a serious problem occurs.

It is also desirable that if the semiconductor manufacturing apparatus is judged to have manifested an abnormality or a semi-abnormality, the judgment unit infer a probable cause of the abnormality or the semi-abnormality by comparing the apparatus information obtained immediately before or after the abnormality or the semi-abnormality is detected with the maintenance information. For instance, it may compare the parameter values indicated by the two types of information and if a parameter indicating an abnormal value is detected, the judgment unit may infer a cause corresponding to the abnormal parameter.

It is desirable that the apparatus information used to infer the cause of the abnormality or the semi-abnormality include one type or a plurality of types of log information selected from a log group constituted of a process log, a trace log and a machine log. The “process log” in this context refers to process data obtained in units of individual lots, whereas the “trace log” refers to process data obtained every second with regard to each wafer. The “machine log” is a log that indicates the operating state of the apparatus. In addition, if a plurality of probable causes for the abnormality or the semi-abnormality are inferred, the frequency with which an abnormality has been attributed to each cause should preferably be referenced. In this case, the plurality of causes may be indicated in the order of frequency with a specific frequency rate attached to each cause.

It is desirable that the part inventory information be referenced if it is judged that a part needs to be replaced based upon the probable cause of the abnormality or the semi-abnormality that has been inferred. In addition, it is desirable that if the referenced part inventory information indicates that the quantity of the part in stock is smaller than a predetermined inventory quantity, automatic order processing for automatically placing an order for the part be executed. Since no parts are allowed to go out of stock and it is assured that all the necessary parts are always available, a part can be replaced quickly whenever necessary.

A second aspect of the present invention provides a factory-side client in a remote maintenance system for a semiconductor manufacturing apparatus, which operates at a factory where at least one semiconductor manufacturing apparatus is installed and comprises a data collection unit that collects status information with regard to the semiconductor manufacturing apparatus and a transmission/reception unit that transmits the status information having been collected to a vendor-side server belonging to a manager who executes maintenance management for the semiconductor manufacturing apparatus via a network enabling bidirectional communication and receives information related to a judgment on an abnormality or a semi-abnormality executed by the vendor-side server based upon the status information and maintenance information stored at the vendor-side server.

It is desirable that the status information include operating state information and apparatus information with regard to the semiconductor manufacturing apparatus. In addition, a judgment may be made based upon the operating state information that an abnormality has occurred if the ratio of unscheduled downtime of the semiconductor manufacturing apparatus exceeds a predetermined ratio, if the length of unscheduled downtime of the semiconductor manufacturing apparatus exceeds a predetermined length of time or if the number of times the semiconductor manufacturing apparatus has experienced unscheduled downtime within a specific length of time exceeds a predetermined value. It is desirable that a judgment that a semi-abnormality has occurred be made based upon the apparatus information if the semiconductor manufacturing apparatus is in a state that does not immediately induce a process down but may lead to a process down as a long period of time elapses. Furthermore, a judgment on a probable cause of the abnormality or the semi-abnormality should be preferably made based upon the apparatus information which, in turn, should include one type or a plurality of types of log information selected from a log group constituted of a process log, a trace log and a machine log.

A third aspect of the present invention provides a computer program that enables the computer to function in conjunction with the factory-side client achieved in the second aspect. A fourth aspect of the present invention provides a storage medium having the computer program stored therein.

A fifth aspect of the present invention provides a vendor-side server in a remote maintenance system for a semiconductor manufacturing apparatus, belonging to a manager who executes maintenance management for at least one semiconductor manufacturing apparatus installed at a factory by receiving status information with regard to the semiconductor manufacturing apparatus collected at a factory-side client operating at the factory via a network enabling bidirectional communication, which comprises a judgment unit that makes a judgment based upon the status information as to whether or not an abnormality or a semi-abnormality has occurred in the corresponding semiconductor manufacturing apparatus, a database unit having stored therein maintenance information with regard to the semiconductor manufacturing apparatus and a transmission/reception unit that receives the status information from the factory-side client and transmits information or an instruction to the factory-side client.

It is desirable that the status information include operating state information and apparatus information with regard to the semiconductor manufacturing apparatus. In addition, it is desirable that the maintenance information include one type of or a plurality of types of information selected from an information group constituted of information indicating factors that cause abnormalities and the corresponding corrective measures with regard to the semiconductor manufacturing apparatus, information indicating normal values of various parameters, information indicating the abnormality history, information indicating the part replacement history, information indicating the part inventory and information indicating the maintenance personnel schedules.

The judgment unit may be set so that it judges that an abnormality has occurred based upon the operating state information if the ratio of unscheduled downtime of the semiconductor manufacturing apparatus exceeds a predetermined ratio, if the length of unscheduled downtime of the semiconductor manufacturing apparatus exceeds a predetermined length of time or if the number of times that the semiconductor manufacturing apparatus has experienced unscheduled downtime within a specific period of time exceeds a predetermined value. It is also desirable that the judgment unit be set so as to judge based upon the apparatus information that a semi-abnormality has occurred if the semiconductor manufacturing apparatus is in a state that does not induce a process down immediately but may lead to a process down as a long period of time elapses.

It is also desirable that if the semiconductor manufacturing apparatus is judged to have manifested an abnormality or a semi-abnormality, the judgment unit infer a probable cause of the abnormality or the semi-abnormality by comparing the apparatus information obtained immediately before or after the abnormality or the semi-abnormality is detected and the maintenance information. It is desirable that the apparatus information used to infer the probable cause of the abnormality or the semi-abnormality include one type or a plurality of types of log information selected from a log group constituted of a process log, a trace log and a machine log.

If a plurality of probable causes for the abnormality or the semi-abnormality are inferred, the frequency at which an abnormality has been attributed to each cause should be referenced. In addition, it is desirable that the part inventory information be referenced if it is judged that a part needs to be replaced based upon the probable cause of the abnormality or the semi-abnormality that has been inferred. It is also desirable that if the referenced part inventory information indicates that the quantity of the part in stock is smaller than a predetermined inventory quantity, automatic order processing for automatically placing an order for the part be executed.

A sixth aspect of the present invention provides a computer program that enables a computer to function in conjunction with the vendor-side server achieved in the fifth aspect. In addition, a seventh aspect of the present invention provides a storage medium having the computer program stored therein.

An eighth aspect of the present invention provides a method for executing remote maintenance on a semiconductor manufacturing apparatus, to be adopted in conjunction with a factory-side client operating at a factory where at least one semiconductor manufacturing apparatus is installed, a vendor-side server belonging to a manager who executes maintenance management for the semiconductor manufacturing apparatus and a network that connects the factory-side client and the vendor-side server with each other so as to enable bidirectional communication. In the remote maintenance method, the factory-side client collects status information with regard to the semiconductor manufacturing apparatus and transmits the status information having been collected to the vendor-side server via the network, whereas the vendor side server executes a judgment based upon the status information and maintenance information with regard to the semiconductor manufacturing apparatus as to whether or not an abnormality or a semi-abnormality has occurred in the corresponding semiconductor manufacturing apparatus and transmits information reflecting the results of the judgment to the factory-side client.

It is desirable that the status information include operating state information and apparatus information with regard to the semiconductor manufacturing apparatus. In addition, a judgment may be made based upon the operating state information -that an abnormality has occurred if the ratio of unscheduled downtime of the semiconductor manufacturing apparatus exceeds a predetermined ratio, if the length of unscheduled downtime of the semiconductor manufacturing apparatus exceeds a predetermined length of time or if the number of times the semiconductor manufacturing apparatus has experienced unscheduled downtime within a specific length of time exceeds a predetermined value. It is desirable that the judgment that a semi-abnormality has occurred be made based upon the apparatus information if the semiconductor manufacturing apparatus is in a state that does not immediately induce a process down but may lead to a process down as a long period of time elapses.

It is desirable that if the semiconductor manufacturing apparatus is judged to have manifested an abnormality or a semi-abnormality, a probable cause of the abnormality or the semi-abnormality be inferred by comparing the apparatus information obtained immediately before or after the abnormality or the semi-abnormality is detected and the maintenance information. It is also desirable that the part inventory information be referenced if it is judged that a part needs to be replaced based upon the probable cause of the abnormality or the semi-abnormality that has been inferred. In addition, it is desirable that if the referenced part inventory information indicates that the quantity of the part in stock is smaller than a predetermined inventory quantity, automatic order processing for automatically placing an order for the part be executed.

A ninth aspect of the present invention provides a method for executing remote maintenance on a semiconductor manufacturing apparatus to be adopted in conjunction with a customer-side server that manages a semiconductor manufacturing apparatus installed in a factory and a management-side server that is connected with the customer-side server via a network enabling bidirectional communication and manages the customer-side server. In the remote maintenance method, the customer-side server collects apparatus information that includes operating state information and failure state information with regard to the semiconductor manufacturing apparatus installed at the factory and maintenance state information indicating the state of maintenance conducted on the semiconductor manufacturing apparatus at the factory and transmits the collected apparatus information to the management-side server, whereas the management-side server ascertains the operating state and the failure state of the semiconductor manufacturing apparatus and the state of the maintenance conducted on the semiconductor manufacturing apparatus at the factory based upon the apparatus information, selects an optimal corrective measures from collective measures stored in a database and transmits information indicating the selected corrective measures to the customer-side server. The method described above allows the management side to obtain the apparatus information even when the apparatus operates at a remote location and thus enables the management side to accurately ascertain the state of the apparatus. In addition, by referencing the database and communicating the information via the network, the optimal corrective measures can be indicated to the customer accurately and quickly.

When adopting the method described above, it is desirable that the management-side server make a judgment based upon the maintenance state as to whether not the semiconductor manufacturing apparatus has been handled without error at the factory and that if there has been an error in handling the semiconductor manufacturing apparatus, the management-side server transmit information indicating remedial measures to be taken to remedy the error to the customer-side server. By providing the customer with the remedial measures as described above, it is possible to prevent the erroneous handling from inducing a failure or a problem.

### BRIEF DESCRIPTION OF THE DRAWINGS

FIG. 1 is a schematic plan view of a semiconductor manufacturing apparatus;

FIG. 2 is a schematic side view of the semiconductor manufacturing apparatus;

FIG. 3 shows the system configuration adopted in an embodiment of the present invention;

FIG. 4 is a functional block diagram of the embodiment of the present invention;

FIG. 5 presents an example of a transmission data-input screen;

FIG. 6 presents a display example of the status information;

FIG. 7 presents an example of an operating state information display screen;

FIG. 8 presents a flowchart of the system operations executed in a first embodiment;

FIG. 9 shows process parameters and the quantities of the individual gases;

FIG. 10 presents a flowchart of the system operations executed in a second embodiment; and

FIG. 11 presents a flowchart of the system operations executed in a third embodiment.

### BEST MODE FOR CARRYING OUT THE INVENTION

The following is an explanation of the preferred embodiments of the present invention, given in reference to the attached drawings. It is to be noted that the same reference numerals are assigned to components achieving substantially identical functions and structural features in the following explanation and the attached drawings to preclude the necessity for a repeated explanation thereof.

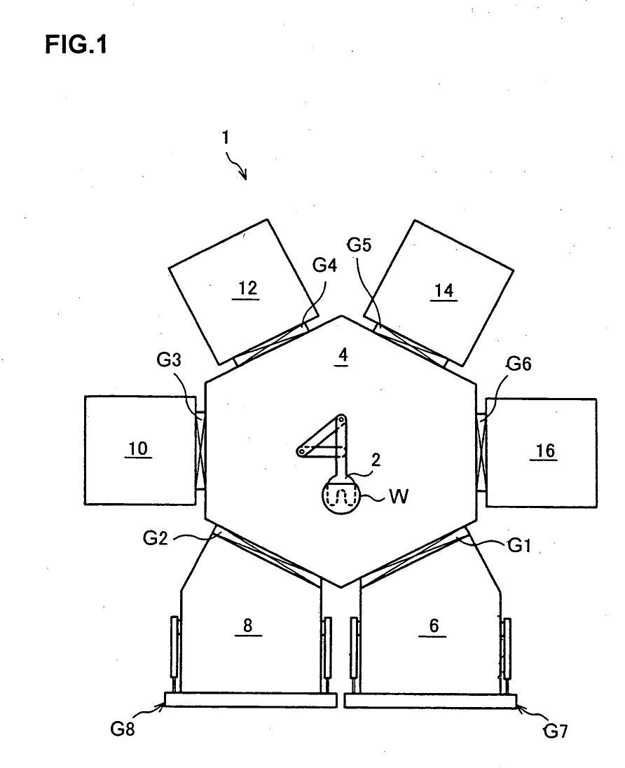

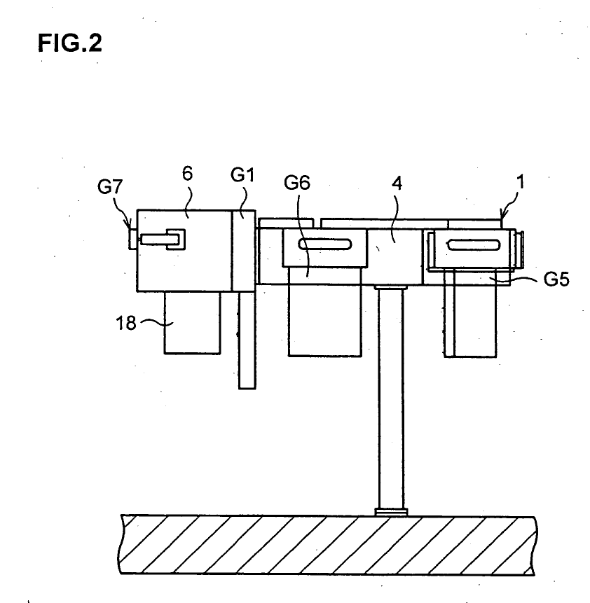

FIGS. 1 and 2 are respectively a schematic plan view and a schematic side view of a multichamber-type manufacturing apparatus. Now, in reference to FIGS. 1 and 2, the overall structure of the manufacturing apparatus 1 is explained. In the manufacturing apparatus 1, first and second load-lock chambers 6 and 8 and first to fourth vacuum processing chambers 10, 12, 14 and 16 are disposed around a vacuum transfer chamber 4 via first to sixth gate valves G1 to G6 respectively. The vacuum transfer chamber 4 includes a transfer arm 2 that transfers a workpiece such as a semiconductor wafer W. The first to fourth vacuum processing chambers 10, 12, 14 and 1.6 are chambers where various types of processing are executed on the semiconductor wafer W.

The first and second load-lock chambers 6 and 8 are provided so as to ensure the semiconductor wafer W is transferred between the vacuum transfer chamber 4 and the outside, where the pressure is at the atmospheric pressure level, while maintaining the pressure of the atmosphere inside the vacuum transfer chamber 4 at a lower level. A pressure adjustment mechanism 18 constituted of a vacuum pump and a gas supply system is provided under the first and second load-lock chambers 6 and 8. With the pressure adjustment mechanism 18, the pressures inside the first and second load-lock chambers 6 and 8 can be set at desirable levels. In addition, the openings on the atmosphere side at the first and second load-lock chambers 6 and 8, which can be freely opened/closed with seventh and eighth gate valves G7 and G8 respectively, are normally kept in a sealed state. Operations to open/close the first to eighth gate valves G1 to G8 are executed by moving the valve elements constituting the gate valves up/down with drive mechanisms (not shown). It is to be noted that FIG. 2 shows the manufacturing apparatus 1 without the first to fourth vacuum processing chambers 10, 12, 14 and 16.

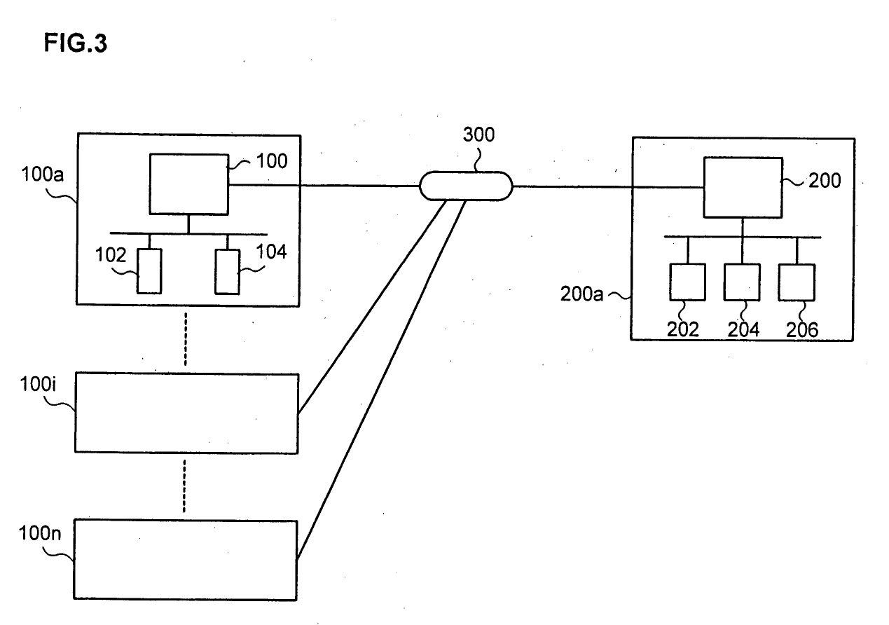

Next, the remote maintenance system for a semiconductor manufacturing apparatus achieved in the first embodiment of the present invention and the method adopted in the remote maintenance system are explained. FIG. 3 shows the system configuration adopted in the embodiment. A factory 100a, where semiconductors are manufactured, is a user of semiconductor manufacturing apparatuses. At the factory 100a, a client 100, semiconductor manufacturing apparatuses 102 and 104 are installed and connected with one another through a LAN (Local Area Network). Factories 100i, . . . , 100n each having a client and semiconductor manufacturing apparatuses assume similar structures. It is to be noted that the types and quantities of semiconductor manufacturing apparatuses installed at the individual factories 100i, . . . , 100n may vary.

A vendor 200a executes maintenance management for the semiconductor manufacturing apparatuses installed at the factories 100a, . . . 100i, . . . , 100n. The vendor 200a is equipped with a server 200 and computers 202, 204 and 206 which are connected with one another through an in-house network. The computers 202, 204 and 206 may be regarded as computers installed in individual departments or individual operation centers of the vendor 200a, and the number of such computers is not limited to this example. The client 100 and the server 200 are connected with each other via the Internet 300 which is a network connecting them so as to enable bidirectional communication.

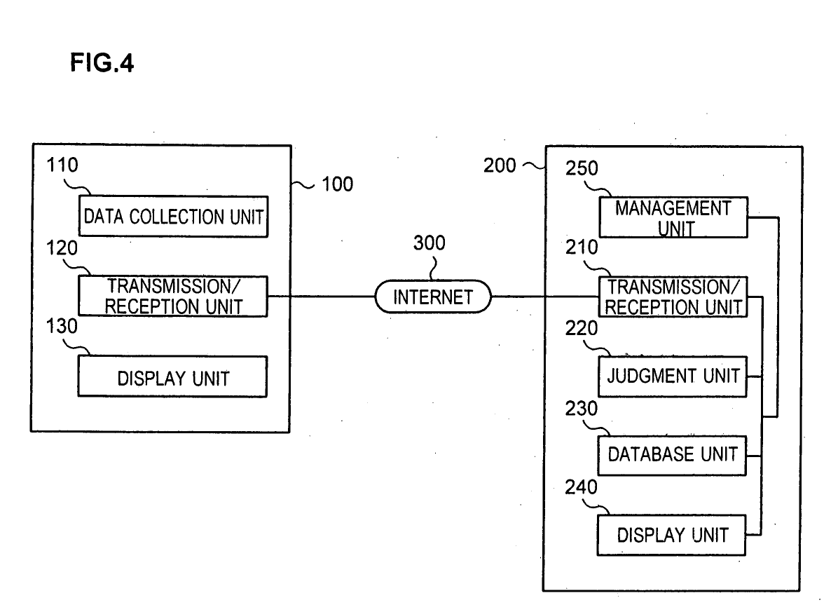

FIG. 4 is a functional block diagram of the client 100 and the server 200. In this diagram, a single client 100 is shown as an example, although there may be a plurality of factories having such a client operating therein. The factory-side client 100 includes a data collection unit 110, a transmission/reception unit 120 and a display unit 130. The data collection unit 110 collects status information with regard to the semiconductor manufacturing apparatuses 102, 104 and the like over predetermined time intervals. The status information of a given semiconductor manufacturing apparatus includes operating state information, apparatus information, failure state information and maintenance state information with regard to the apparatus. The transmission/reception unit 120 transmits the status information having been collected to the server 200 at the vendor 200a via the Internet 300, and also receives information transmitted from the server 200. The display unit 130 displays various types of information.

The server 200 at the vendor 200a includes a transmission/reception unit 210, a judgment unit 220, a database unit 230, a display unit 240 and a management unit 250. The transmission/reception unit 210 receives the status information provided by the factory-side client 100 and transmits information or instructions to the client 100. The judgment unit 220 makes a judgment based upon status information as to whether or not an abnormality has occurred in the corresponding apparatus. At the database unit 230, maintenance information such as factors that cause abnormalities and the corresponding corrective measures with regard to individual types of apparatuses, normal values of various parameters, abnormality histories and part replacement histories corresponding to individual apparatuses, part inventory information and maintenance personnel schedules is stored in memory. The data at the database unit are updated as the data statuses change. The display unit 240 displays various types of information. The management unit 250 manages various types of information, executes processing based upon the results of the judgment executed by the judgment unit 220 and issues instructions to conduct a search at the database unit 230 to send notices to the client 100 and related departments and the like.

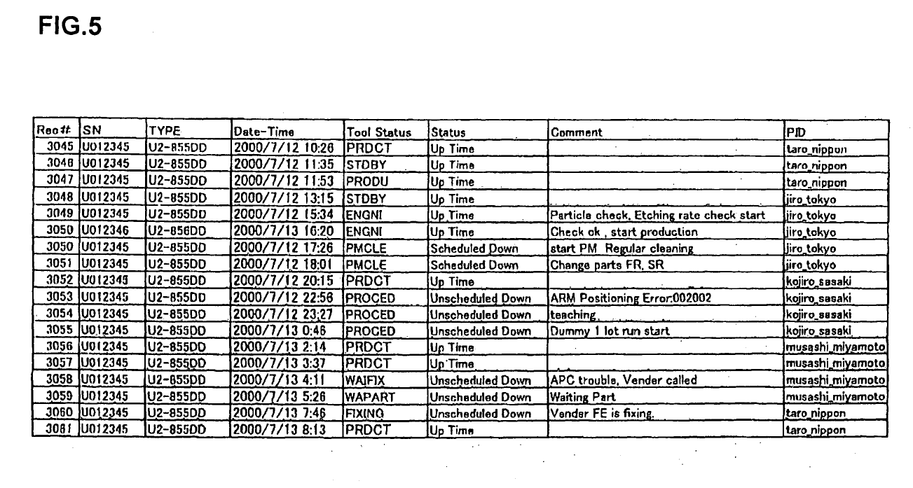

FIGS. 5 to 7 present examples of the apparatus operating state information. FIG. 5 presents an example of an input screen in which data to be transmitted by the factory-side client 100 are entered. The transmission data on a given semiconductor manufacturing apparatus include, for instance, the serial number (SN: serial number), the apparatus type (TYPE), the date and time (Date-Time), the apparatus status (Tool Status), the status (Status), the failure code, comments (Comment) and the personnel ID (PID; personal ID).

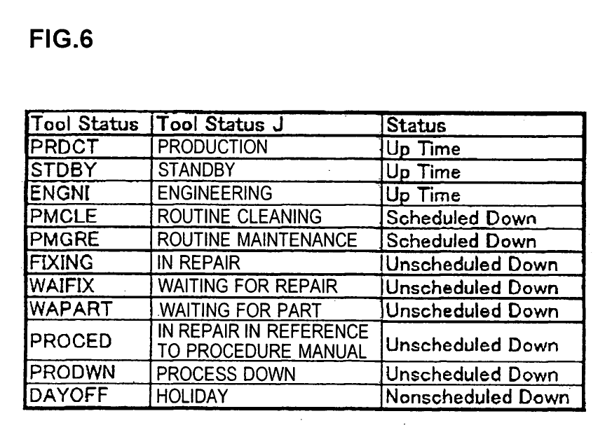

FIG. 6 presents an example of the status information and the apparatus status information. The status information indicates the operating status of the apparatus, e.g. UP Time (operating), Scheduled Down (scheduled downtime) or Unscheduled Down (unscheduled downtime). The apparatus status information indicates the status of the apparatus in further detail. Namely, an apparatus currently in the UP Time state may be a PRDCT (production) status, an STDBY (standby) status or an ENGNI .(engineering) status. An apparatus currently in the Scheduled Down state may be undergoing PMCLE (routine cleaning) or PMGRE (routine maintenance). An apparatus in the Unscheduled Down state may be undergoing FIXING (in repair), may be in a WAIFIX (repair wait) status or a WAPART (part-wait) status, may be undergoing PROSED (repair conducted in reference to the procedure manual) or may be in a PRODWN (process down) status. In the example in FIG. 6, “Nonscheduled Down” more specifically refers to DAYOFF (holiday) status. While the operating state information includes both the status information and the apparatus status information in the embodiment, it may be constituted of either the status information or the apparatus status information alone.

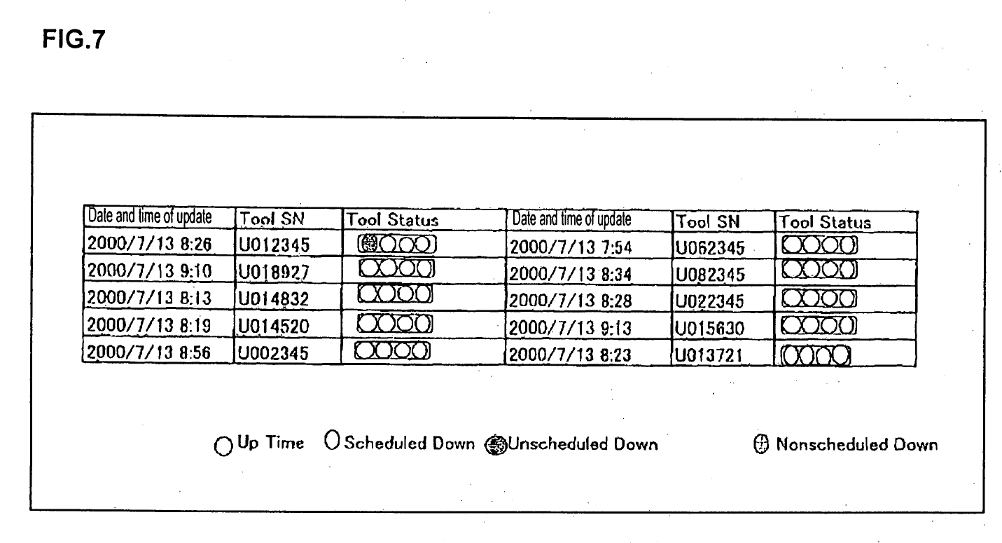

FIG. 7 shows the operating state display screen brought up at the vendor-side server 200 based upon the received information. In the screen, the dates and time points of data entries, the corresponding apparatuses and their statuses are indicated. As a pointer is placed over a specific apparatus and clicked in the display screen, detailed information on the apparatus is brought up on display for review. The operating state information is primarily used to execute a judgment on abnormalities occurring in apparatuses.

The apparatus information with regard to a given apparatus may include, for instance, various logs such as a process log, a machine log and a trace log and data indicating particles, defects and yield. The process log refers to process data indicating the values of various parameters obtained in correspondence to each lot, e.g., the pressure value of the process gas and the average, the maximum value and the minimum value of the RF power value and the like. The machine log indicates the operating state of the apparatus. The trace log refers to process data of each wafer, obtained over predetermined time intervals e.g., every second. The apparatus information is primarily used to execute a judgment on the probable cause of an abnormality.

The failure state information of a given apparatus indicates the state of failure in the apparatus. The maintenance state information indicates the state of the maintenance conducted on the apparatus at the factory. It is to be noted that in the system according to the present invention, the operating state information may contain part of or an overview of the failure state information and the maintenance state information. For instance, the failure codes in FIGS. 5 and 6 relate to the various failure states, whereas PMCLE (routine cleaning), PMGRE (a routine maintenance), FIXING (in repair), WAIFIX (repair wait), WAPART (part wait) and PROCED (in repair in conformance to the procedure manual) in FIGS. 5 and 6 relate to various maintenance states.

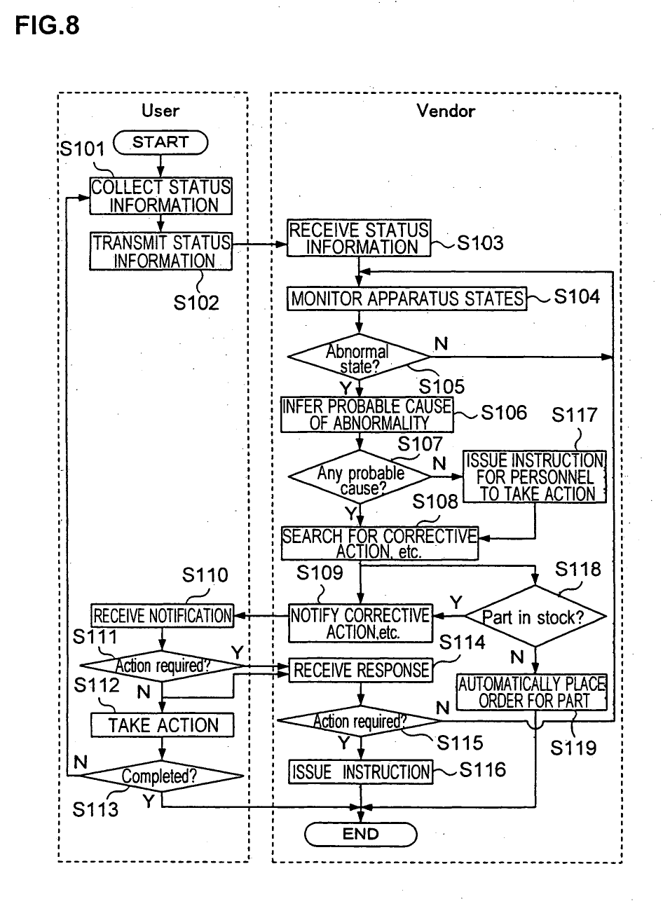

Next, the method adopted to execute remote maintenance on semiconductor manufacturing apparatuses by using the system achieved in the embodiment is explained in detail in reference to FIG. 8. FIG. 8 presents a flowchart of the system operations executed in the embodiment. The data collection unit 110 at the client 100 installed at each factory collects the status information with regard to the semiconductor manufacturing apparatuses connected to the client through the LAN (step S101). Each set of status information contains the operating state information and the apparatus information with regard to the corresponding apparatus as described earlier.

The status information having been collected is transmitted by the transmission/reception unit 120 to the server 200 at the vendor 200a via the Internet 300 (step S102). The information is collected and transmitted in steps S101 and S102 over predetermined time intervals, e.g., every 5 minutes, in the embodiment. However, the predetermined time intervals may be 30 minutes or 1 hour instead of 5 minutes to facilitate the management or to lessen the load on the apparatuses. In addition, the operating state information may be transmitted only when there has been a change in the operating state of the corresponding apparatus.

The status information transmitted as described above is received at the transmission/reception unit 210 of the server 200 at the vendor 200a (step S103). Based upon the status information, the server 200 monitors the statuses of the apparatuses for any changes (step S104). The details of the apparatus statuses being monitored can be checked in the screen shown in FIG. 7. In step S104, various types of checks and calculations of parameters are executed in order to execute the abnormality judgment.

Next, the judgment unit 220 executes the abnormality judgment (step S105). The following is an explanation of an example of a method that may be adopted in the abnormality judgment. The judgment as to whether or not an abnormality has occurred in a given apparatus may be executed based upon the unscheduled downtime that the apparatus experiences. In the first method of the abnormality judgment, it is judged that an abnormality has occurred if the ratio of unscheduled downtime to a predetermined length of time exceeds a predetermined ratio. For instance, when the predetermined length of time is set at 5 hours and the predetermined ratio is set at 20%, it is decided that an abnormality has occurred if the length of the unscheduled downtime exceeds 1 hour. In order to enable the judgment unit 220 to execute such a judgment, the server 200 calculates the total length of unscheduled downtime within the predetermined length of time and the ratio of the total length of time to the predetermined length of time.

In the second method, it is judged that an abnormality has occurred if the length of the unscheduled downtime equal to or exceeds a predetermined length of time. For instance, when the predetermined length of time is set at 1 hour, it is judged that an abnormality has occurred if the length of the unscheduled downtime exceeds 1 hour. In a third method, it is judged that an abnormality has occurred if the number of times the apparatus has experienced unscheduled downtime within a predetermined length of time exceeds a specific value. For instance, when the predetermined length of time is set at 5 hours and the predetermined value is set at 5, it is judged that an abnormality has occurred if the apparatus experiences unscheduled downtime 6 times or more within 5 hours. In order to enable the judgment unit 220 to execute such a judgment, the server 200 calculates the number of times that the apparatus experiences unscheduled downtime within the specific length of time.

Alternatively, it may be judged that an abnormality has occurred if an operator at the factory enters information indicating an abnormality in the apparatus in the comment section in the operating state information input by the apparatus operator instead of based upon the unscheduled downtime the apparatus experiences. As a further alternative, the judgment may be made based upon the length of PRODWN indicated in the apparatus status information in FIG. 6 or the number of times PRODWN is indicated in the apparatus status information. In addition, the predetermined ratio, the predetermined value and the like mentioned above should be set as appropriate in correspondence to the specific process conditions, the specific apparatus type and the like.

If it is judged in step S105 that no abnormality has occurred, the server 200 continuously monitors the apparatus statuses. If, on the other hand, it is judged that an abnormality has occurred, a probable cause of the abnormality is inferred by comparing the maintenance information and the apparatus information obtained immediately before or after the abnormality is judged to have occurred (step S106). The maintenance information stored at the database unit 230 includes factors that cause abnormalities stored in correspondence to individual apparatus types, normal values of various parameters and abnormality histories and part replacement histories stored in correspondence to the individual apparatuses. Accordingly, the values indicated by the various parameters are compared with the normal values in the database by referencing these data to identify which parameter indicates an abnormality. If a parameter indicating an abnormal value is detected, the cause corresponding to the abnormal parameter is inferred.

Various types of logs are included in the apparatus information. For instance, the parameter values indicated in the process log may be compared with the corresponding normal values stored in memory in advance at the database. Then, the parameter indicating an abnormal value is estimated and the cause of the abnormality corresponding to the abnormal parameter is searched in the database. An abnormality judgment can be executed in a similar manner by using the trace log. During the abnormality judgment, data obtained by averaging the data in the process log and data in the trace log may be used. Alternatively, either the process log or the trace log alone may be used. As a further alternative, both the process log and the trace log may be utilized in different manners, by first roughly estimating the abnormal parameter indicating an abnormal value with the process log and then exactly identifying the abnormal parameter through a more detailed investigation executed based upon the data in the trace log. In addition, after a process is completed, an acceptability judgment may be executed by comparing the average values corresponding to the process and the actual values detected during the process.

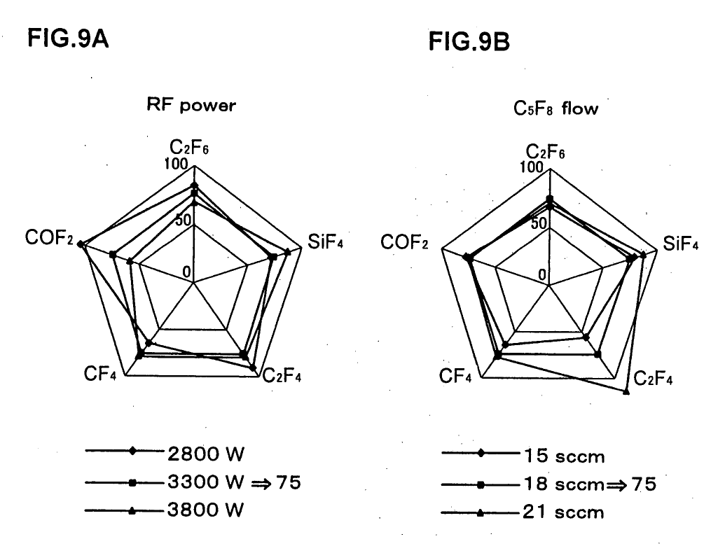

FIG. 9, which presents the results of monitoring the exhaust gas resulting from a given process, indicates the quantities of the various gases C₂F₆, SiF₄, C₂F₄, CF₄ and COF₂ contained in the exhaust gas. The parameter in the diagram in FIG. 9A is the value representing the level of the high-frequency power that is applied, whereas the parameter in the diagram in FIG. 9B is the flow rate of C₅F₈. The normal values stipulated in the manufacturing standard for this particular process are a power level of 3300 W and a C₅F₈ flow rate of 18 sccm.

In FIG. 9A, when the level of the high-frequency power that is applied is 2800 W, the quantity of COF₂ shows a marked increase, the quantity of C₂F₄ also increases but the quantity of CF₄ decreases compared to the corresponding quantities when the level of the power is 3300 W. When the power level is 3800 W, the quantity of SiF₄ shows an increase and the quantity of COF₂ decreases compared to those when the power level is at 3300 W. In FIG. 9B, the quantities of C₂F₄ and CF₄ are smaller when the flow rate of C₅F₈ is 15 sccm, compared to the corresponding quantities when the C₅F₈ flow rate is 18 sccm. When the C₅F₈ flow rate is 21 sccm, the quantity of C₂F₄ shows a marked increase over the quantity of C₂F₄ when the C₅F₈ flow rate is 18 sccm.

It is known that the quantities of the individual gases contained in the exhaust gas fluctuate as the level of the high-frequency power which is applied changes and as the C₅F₈ flow rate changes, as described above. Accordingly, by storing in memory the various parameters, conditions induced as they fluctuate and the tendencies of such conditions at the database, the stored data can be effectively utilized to infer a probable cause of an abnormality.

When the abnormality judgment is executed by using the machine log, it is as to whether or not the operation is being executed in conformance to the program or the flow through which the process must be executed. If the correct operation is not in progress, the probable cause of the abnormality related to this operational failure is searched in the database. If there are a plurality of parameters each indicating an abnormal value in the process data, the probable cause of a given abnormality may be searched in relation to an abnormality indicated in another log such as the machine log. For instance, an approximate area where the abnormality has occurred may be first detected by using the machine log and then the values of related parameters may be compared with the corresponding threshold values by using the trace log or the like so as to detect the exact factor causing of the abnormality having occurred at the area.

Through the search, it is determined whether or not there is any probable cause that has been inferred (step S107). If there is any cause that has been inferred, a search is conducted for the proper corrective measures to be taken against the inferred cause and any part required to take the corrective measures, any jigs required when taking the measures, the schedules of the maintenance personnel (engineers) and the like (step S108). Based upon the results of the search, information indicating the cause of the abnormality, the corrective measures, any required parts, the minimum wait period before the abnormality can be corrected is transmitted to the factory side (step S 109). The specific contents of the information transmitted in this step may be read, for instance, “abnormal element: lowered gas pressure, inferred cause: damage at part ##, corrective measures: 1) replace parts ## and xx, 2) clean part x, engineer: expected arrival time; month/day/time”.

It is to be noted that if there are a plurality of probable causes for an abnormality, the frequency of with which each cause appears in the data may be referenced in the database and the plurality of causes may be indicated in the order of the frequency with which they appear. Alternatively, the probable causes may be ranked by referencing both the abnormality histories and the part replacement histories or either type of history corresponding to individual apparatuses and may be indicated in the ranking order. For instance, if the high-frequency power applied to the upper electrode indicates an abnormal value relative to the threshold value and there are a plurality of probable causes for the high-frequency power abnormality inferred by conducting a search of the database, the frequency with which each cause occurs may be displayed as a percentage and the probable causes and the corresponding corrective measures may be indicated in the order with which they occur in the data in the database with regard to the specific apparatus type.

If the results of the search executed in step S108 indicate that the corrective measures simply require an instruction to be provided to the factory, the instruction details are provided to the factory accordingly. If it is judged that a part needs to be replaced as the corrective measures, the part inventory information is referenced in the database (step S118). If spare units of the part are in stock and a replacement part needs to be shipped to the factory, a message notifying that a replacement part is to be shipped is sent to the factory and a replacement part shipment instruction is sent to the related department at the vendor. If the referenced part inventory information indicates that the number of units of the part in stock is smaller than a predetermined inventory quantity, automatic order processing to automatically place an order for the part is executed (step S119). It is to be noted that if no probable cause is ascertained in step S107, an instruction for the maintenance personnel in charge to initiate appropriate action is issued (step S117). The processing described above is executed by the management unit 250.

The information transmitted in step S109 is received at the factory (step S110). Then, a judgment is made as to whether or not the problem needs to be handled by the maintenance personnel (engineer) dispatched by the vendor (step S111). If it is judged that the problem needs to be handled by the maintenance personnel, a message requesting a maintenance personnel service is transmitted to the vendor. If it is judged, on the other hand, that the problem does not require the maintenance personnel service, a message indicating that the maintenance personnel is not required is transmitted to the vendor and the problem is handled by the personnel at the factory (step S112). Then, a judgment is made as to whether or not the processing has been completed (step S113). If it is judged that the processing has been completed, the operational flow in FIG. 8 ends. If it is judged that the processing has not been completed yet, the operation returns to step S101 and the processing is executed repeatedly until it is completed. At the vendor side, the message indicating whether or not the maintenance personnel service is required as judged in step S111 is received (step S114), a judgment is made as to whether or not the vendor side is required to take further action (step S115), and if necessary, an instruction for the maintenance personnel (engineer) in charge to take appropriate action is issued (step S116) before ending the processing. If it is judged in step S115 that no further action is required, the operation proceeds to step S104 to keep monitoring the data.

As described above, data are exchanged via the Internet and a search is executed by referencing the database in the event of a failure. Thus, remote management of semiconductor manufacturing apparatuses is enabled, and when a failure occurs, the factor causing of the failure can be identified quickly and accurately. Since the information with regard to a given apparatus can be examined in a comprehensive manner, enabling an accurate diagnosis, it becomes possible to offer consultation services for apparatuses. In addition, since the status information on the apparatuses can be displayed at a plurality of computers installed on the network, the apparatuses can be monitored by a plurality of people at the same time, thereby ensuring that the information is understood and shared effectively. Furthermore, the information on the apparatuses can be made available for display at a display device connected via a network anywhere in the world. Thus, by stationing personnel in specific regions of the world and having them monitor apparatuses operating in other parts of the world, it becomes possible to offer a high-quality round-the-clock support service with the personnel on day shift alone without needing to retain personnel on night shift. Alternatively, by stationing a sufficient number of operators to provide round-the-clock support service at, at least, one location in the world, apparatuses used all over the world can be monitored by a minimum number of support operators.

Next, the remote maintenance system for semiconductor manufacturing apparatuses achieved in the second embodiment of the present invention and the method adopted in the system are explained. This embodiment differs from the first embodiment in that the factory side client and the vendor-side server are connected with each other at all times and in that a judgment is executed as to whether or not a semi-abnormality has occurred as well as whether or not an abnormality has occurred, as described earlier. Since the system configuration adopted in the embodiment is similar to that in the first embodiment, its explanation is omitted.

The factory-side clients and the vendor-side server in the embodiment adopt structures similar to those shown in FIG. 4. The factory-side clients 100 in the embodiment each include a data collection unit 110, a transmission/reception unit 120 and a display unit 130. The data collection unit 110 collects status information with regard to the semiconductor manufacturing apparatuses 102, 104 and the like over predetermined time intervals. The status information of a given semiconductor manufacturing apparatus includes operating state information, apparatus information and the like with regard to the apparatus. The transmission/reception unit 120 transmits the status information having been collected to the server 200 at the vendor 200a via the Internet 300, and also receives information transmitted from the server 200. The display unit 130 displays various types of information.

The server 200 at the vendor 200a in the embodiment includes a transmission/reception unit 210, a judgment unit 220, a database unit 230, a display unit 240 and a management unit 250. The transmission/reception unit 210 receives the status information provided by the factory-side client 100 and transmits information or instructions to the client 100. The judgment unit 220 makes a judgment based upon status information as to whether or not an abnormality or a semi-abnormality has occurred in the corresponding apparatus. At the database unit 230, maintenance information such as factors that cause abnormalities and the corresponding corrective measures with regard to individual types of apparatuses, normal values, abnormal values and semi-abnormal values of various parameters, abnormality histories and part replacement histories corresponding to individual apparatuses, part inventory information and maintenance personnel schedules is stored in memory. The data at the database unit are updated as the data statuses change. The display unit 240 displays various types of information. The management unit 250 manages various types of information, executes processing based upon the results of the judgment executed by the judgment unit 220 and issues instructions to conduct a search at the database unit 230 to send notices to the client 100 and related departments and the like.

In this document, an abnormal value is defined as a value setting at which the apparatus is caused to go down. A semi-abnormal value is defined as a value setting that does not induce an immediate downtime of the apparatus but may lead to a downtime as a long time elapses. A state in which there is a parameter indicating a semi-abnormal value is defined as a semi-abnormal state.

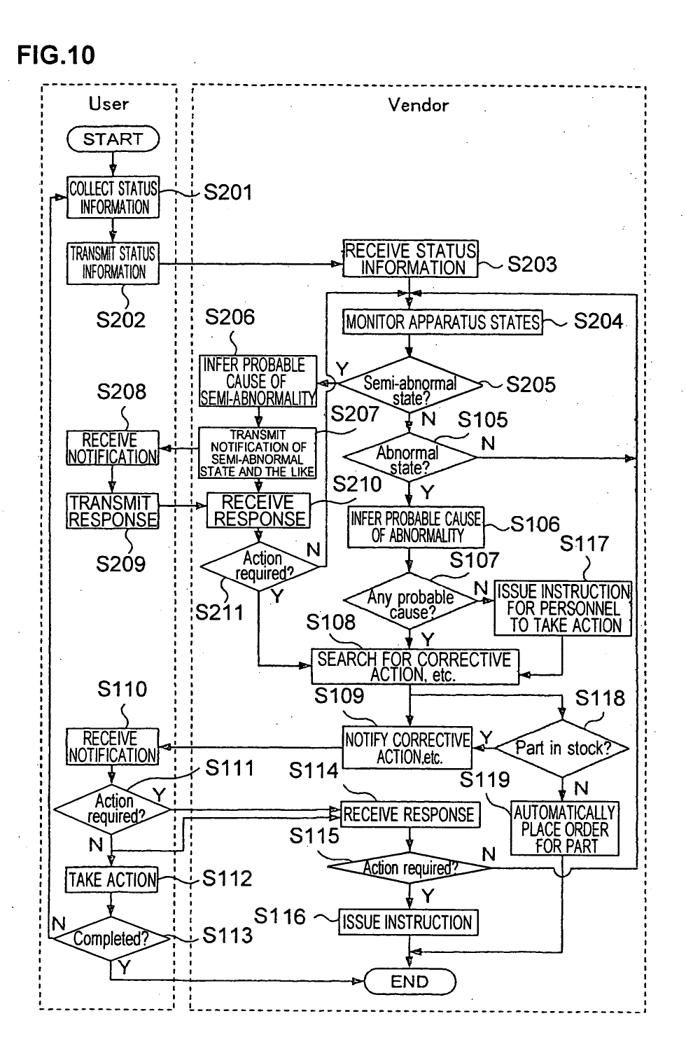

Next, the method adopted to execute remote maintenance on semiconductor manufacturing apparatuses by using the system achieved in the embodiment is explained in detail in reference to FIG. 10. FIG. 10 presents a flowchart of the system operations executed in the embodiment. The data collection unit 110 at the client 100 installed at each factory collects the status information with regard to the semiconductor manufacturing apparatuses connected to the client through the LAN (step S201). Each set of status information contains the operating state information and the apparatus information with regard to the corresponding apparatus as described earlier.

The status information having been collected is transmitted by the transmission/reception unit 120 to the server 200 at the vendor 200a via the Internet 300 (step S202). The information is collected and transmitted in steps S201 and S202 constantly in the embodiment.

The status information transmitted as described above is received at the transmission/reception unit 210 of the server 200 at the vendor 200a (step S203). Based upon the status information, the server 200 monitors the statuses of the apparatuses in substantially real time for any changes (step S204). The details of the apparatus statuses being monitored can be checked in the screen shown in FIG. 7 and FIG. 8. In step S204, various types of checks and calculations of parameters are executed in order to execute the abnormality or semi-abnormality judgment.

The judgment as to whether or not a semi-abnormality has occurred may be executed through a method which is basically identical to the method of the abnormality judgment, by simply changing the threshold values that are used. Alternatively, different parameters and items from those used in the abnormality judgment may be prepared for the semi-abnormality judgment.

Through either of the judgment methods described above, a judgment is made by the judgment unit 220 as to whether or not a semi-abnormality has occurred (step S205). If it is judged that no semi-abnormality has occurred, the operation proceeds to the next step to execute a judgment as to whether or not an abnormality has occurred, as in the first embodiment (step S105). Subsequently, an operation similar to that in the first embodiment is executed.

If it is judged that a semi-abnormality has occurred, a probable cause for the semi-abnormality and the corresponding corrective measures are ascertained by searching the information stored at the database unit 230 (step S206). The method with which the probable cause is inferred is similar to the method with which the probable cause of an abnormality is inferred in the first embodiment. Then, a message notifying that the apparatus is in a semi-abnormal state, the probable cause for the semi-abnormality and the corresponding corrective measures is transmitted to the factory-side client 100 (step S207). In this situation, too, if there are a plurality of probable causes, the frequency with which each cause appears may be referenced at the database so as to indicate the plurality of probable causes and the corresponding corrective measures in the order of frequency with which they appear.

The message is received at the factory (step S208). Then, appropriate action is taken based upon the details of the message and a response to the message is transmitted from the client 100 to the server 200 at the vendor (step S209). The response from the factory is received at the server 200 (step S210) and a judgment is made as to whether or not further action is required (step S211). If it is judged that further action is required, the operation proceeds to step S108 to execute a search to ascertain the appropriate corrective measures, a required part, a required jig, the schedule of the maintenance personnel and the like. If no further action is required, the operation proceeds to step S204 to keep monitoring the data.

The embodiment described above achieves the following advantages in addition to the advantages of the first embodiment. Since the client 100 and the server 200 are connected with each other at all times and the can be exchanged at all times as well, corrective actions can be taken in real time. In addition, a judgment is made as to whether or not a given apparatus is in a semi-abnormal state so as to detect any sign of unscheduled downtime due to a problem if the apparatus is judged to be in a semi-abnormal state and so as to issue an instruction for appropriate measures to be taken to avoid the unscheduled downtime accordingly. Thus, action can be taken before the apparatus enters a state of grave failure and, as a result, the operation rate can be further improved.

While a message is provided by the vendor to the factory side in the event of an abnormality in the example explained above, a message may be transmitted in other situations as well. For instance, since the frequency with which a failure occurs in each apparatus, the maintenance history of the apparatus and the like can be ascertained by managing the database, messages indicating high failure frequency and effective corrective measures may be provided for apparatuses experiencing frequent failures in the individual types of apparatuses. In addition, based upon the part replacement history of each apparatus, the timing of various part replacements, routine cleaning, routine inspection and like may be monitored so as to send a message indicating that the apparatus is due for a part replacement, cleaning, routine inspection or the like as the due date approaches.

Next, the remote maintenance system for semiconductor manufacturing apparatuses achieved in the third embodiment of the present invention and the method adopted in the system are explained. Since the system configuration adopted in the embodiment is similar to that in the first embodiment shown in FIG. 3, its explanation is omitted. The embodiment is characterized in that a judgment is executed as to whether or not any error has been committed in the action taken for maintenance and that if there has been an error, it is remedied. The following explanation focuses on this point.

While FIG. 4 can be used as the functional block diagram of the embodiment as well, the functions of the individual units somewhat differ from those in the first embodiment. Now, in reference to FIG. 4, the functions of the various units in the embodiment are explained. FIG. 4 is a functional block diagram of the client 100 and the server 200. In this diagram, a single client 100 as an example although there may be a plurality of factories each having such a client operating therein. The factory-side client 100 includes a data collection unit 110, a transmission/reception unit 120 and a display unit 130. The data collection unit 110 collects status information with regard to the semiconductor manufacturing apparatuses 102, 104 and the like. The transmission/reception unit 120 transmits the status information having been collected to the server 200 at the vendor 200a via the Internet 300, and also receives information transmitted from the server 200. The display unit 130 displays various types of information.

The server 200 at the vendor 200a includes a transmission/reception unit 210, a judgment unit 220, a database unit 230, a display unit 240 and a management unit 250. The transmission/reception unit 210 receives the status information provided by the factory-side client 100 and transmits information or instructions to the client 100. The judgment unit 220 makes a judgment as to whether or not there has been any error in the action taken with regard to a given apparatus at the factory based upon the corresponding status information. At the database unit 230, information indicating corrective measures corresponding to specific failure states in individual types of apparatuses, information indicating abnormality histories and part replacement histories of the individual apparatuses and the like are stored. The data at the database unit are updated as the data statuses change. The display unit 240 displays various types of information. The management unit 250 ascertains operating states and failure states of the apparatuses and the states of maintenance performed on the apparatuses at the factory based upon the status information, manages various types of information, executes processing based upon the results of the judgment executed by the judgment unit 220 and issues instructions to conduct a search at the database unit 230 to send notices to the client.

As in the first embodiment, each set of status information includes information indicating the apparatus operating state, apparatus information, failure state information, maintenance state information and the like. The status information may include, for instance, the apparatus ID, the apparatus type, the date and time, the apparatus status, an error message indicating a failure state (alarm), comments indicating operation details and maintenance details and the like. The factory-side client 100 transmits such information over predetermined time intervals or each time there has been a change in the apparatus operating state or the apparatus maintenance state. The information allows the server 200 at the vendor to keep abreast of the states of the apparatuses at the factory at all times.

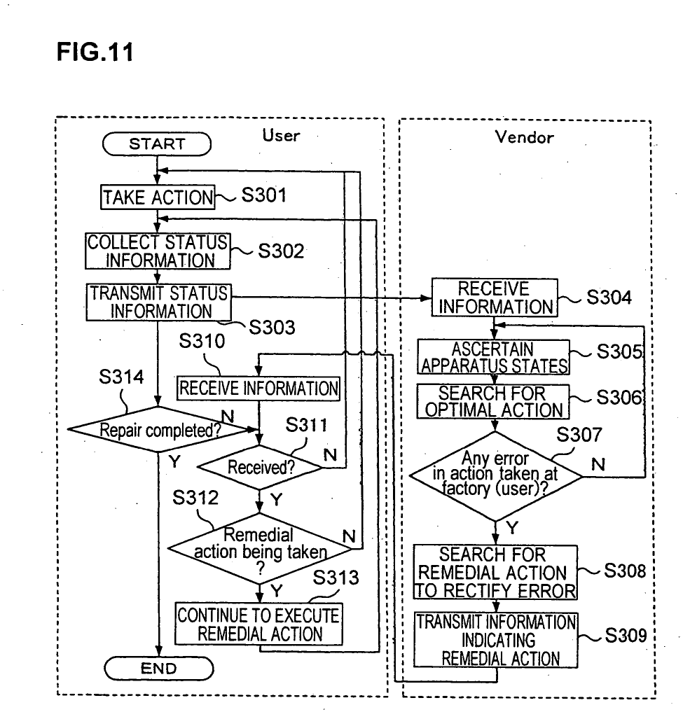

FIG. 11 presents a flowchart of the operations executed in the system described above. Action is taken on each semiconductor manufacturing apparatus at each factory (step S301). The data collection unit 110 at the client 100 installed at the factory collects the status information with regard to the semiconductor manufacturing apparatuses connected to the client through the LAN (step S302). Each set of status information contains the operating state information, the failure state information and the maintenance state information indicating the state of maintenance conducted on the apparatus at the factory. The status information having been collected is transmitted by the transmission/reception unit 120 to the server 200 at the vendor 200a via the Internet 300 (step S303). The information may be collected and transmitted in steps S302 and S303 over predetermined time intervals, or it may be collected and transmitted constantly by sustaining the connection between the client 100 and the server 200 at all times. As a further alternative, the status information may be transmitted every time there has been a change in the operating state, every time a failure occurs or each time there is a change in maintenance details.

The status information thus transmitted is received at the transmission/reception unit 210 of the server 200 at the vendor 200a (step S304). Based upon the status information, the server 200 ascertains the operating state and the failure state of each apparatus and the state of maintenance performed on the apparatus at the factory (step S305). During this process, the state of the apparatus may be ascertained based upon a command included in the apparatus status or based upon a keyword contained in the comments.

Then, optimal measures to be taken are searched at the database unit 230 in correspondence to the apparatus state (step S306). For instance, if a failure has occurred in the apparatus and an error message has been issued, the corrective measures corresponding to the message is searched at the database unit 230. Next, the judgment unit 220 executes a judgment based upon the status information as to whether or not the action taken at the factory with regard to a particular semiconductor manufacturing apparatus has been correct (step S307). If there has been an error, the action to be taken to remedy the error is searched at the database unit 230 (step S308). Then, a message indicating that there has been an error in the action and the corresponding remedial action to remedy the error is transmitted to the factory-side client 100 (step S309). If, on the other hand, it is judged in step S307 that there has been no error, the apparatus state is continuously monitored.

At the factory side, the information transmitted in step S309 is received (step S310). Then, a judgment is made at the factory side as to whether not any such information has been received (step S311). If the reception is verified, a judgment is made as to whether or not the remedial action for remedying the error is being taken (step S312). If the action is being taken, the remedial action is continuously executed (step S313). Subsequently, the operation returns to step S302 to keep collecting the status information. If the reception is not verified in step S311, the operation returns to step S301 to continuously execute the action. If it is judged in step S312 that the remedial action for remedying the error is not being taken, the operation returns to step S301 to execute the action. It is to be noted that after transmitting the information in step S303, a judgment is executed at the factory side as to whether or not the repair has been completed (step S314). If it is judged that the repair has been completed, the processing ends. If, on the other hand, the repair has not been completed, the operation shifts to step S311 to execute a judgment as to whether or not information has been received from the vendor and subsequently, the processing is executed as described above.

As described above, the management side is enabled to obtain information regarding apparatuses operating at remote locations via the Internet to ascertain the failure state of apparatuses and the states of actions taken as corrective measures at all times in the embodiment. In addition, the optimal corrective measures can be ascertained promptly by referencing the data base. Thus, even when there is an error made in the action taken at the factory, the optimal remedial action to be taken to remedy the error can be indicated promptly.

It is to be noted that the data exchanged between the client 100 and the server 200 in the embodiments described above may be coded before transmission. In such a case, the coded data may be taken into a database via a firewall to decode the data. Alternatively, a firewall may be installed at each apparatus so as to allow the individual apparatuses to set their own codes individually. In such a case, third parties cannot access the information and thus, a system assuring a high degree of security can be provided.

In addition, a judgment unit having functions similar to those of the judgment unit 220 at the vendor-side server 200 may be provided at each factory-side client 100 to enable the client 100 to make similar judgments in the embodiments described above.

While the invention has been particularly shown and described with respect to preferred embodiments thereof by referring to the attached drawings, the present invention is not limited to these examples and it will be understood by those skilled in the art that various changes in form and detail may be made therein without departing from the spirit, scope and teaching of the invention.

For instance, while an example of a semiconductor manufacturing apparatuses in conjunction with which the present invention is embodied is illustrated in FIGS. 1 and 2, the present invention is not limited to this particular example.

As described in detail, according to the present invention, remote management of a semiconductor manufacturing apparatus is enabled, and when a failure occurs, the factor causing the failure can be identified quickly and accurately. In addition, since an instruction for corrective measures to be taken to avert unscheduled downtime, which may be induced by an ensuing problem, is issued in a semi-abnormal state, appropriate action can be taken before the apparatus enters a state of serious failure and thus, it is possible to further improve the operation rate and the throughput. Furthermore, by stationing personnel in specific regions of the world and having them monitor apparatuses operating in other parts of the world, it becomes possible to offer a high-quality round-the-clock support service with the personnel on day shift alone without needing to retain personnel on night shift. Alternatively, by stationing a sufficient number of operators to provide round-the-clock support service at, at least that one location in the world, apparatuses used all over the world can be monitored with a minimum number of support operators. In another aspect of the present invention, appropriate maintenance services can be provided even for apparatuses operating at remote locations by ascertaining the operating states and the failure states of the apparatuses, and the states of maintenance performed by the customers. In particular, even if erroneous action has been taken by a customer, the error can be immediately corrected and the optimal remedial measures to be taken to remedy the error can be provided. As a result, a serious failure that may be induced by the erroneous action can be averted to further contribute to the improvement of the operation rate and the throughput:

Industrial Applicability

The present invention may be adopted in a remote maintenance system for semiconductor manufacturing apparatuses to be employed to manage and perform maintenance on semiconductor manufacturing apparatuses such as etching apparatuses from a remote location, a factory-side client and a vendor-side server ideal in an application in conjunction with the system, a method and a program for executing remote maintenance for semiconductor manufacturing apparatuses and a storage medium having the program stored therein.

What is claimed is:

1. A remote maintenance system for a semiconductor manufacturing apparatus, comprising:
a factory-side client operating at a factory where at least one semiconductor manufacturing apparatus is installed;
a vendor-side server belonging to a manager who carries out maintenance management for said semiconductor manufacturing apparatus; and
a network that connects said factory-side client and said vendor-side server with each other so as to enable bidirectional communication, wherein:
said factory-side client includes a data collection unit that collects status information with regard to said semiconductor manufacturing apparatus and a transmission/reception unit that transmits said status information having been collected to said vendor-side server via said network and receives information transmitted from said vendor-side server; and
said vendor-side server includes a judgment unit that judges whether or not said semiconductor manufacturing apparatus corresponding to said status information manifests an abnormality or a semi-abnormality based upon said status information, a database unit in which maintenance information with regard to said semiconductor manufacturing apparatus is stored in memory and a transmission/reception unit that receives said status information from said factory-side client and transmits information or an instruction to said factory-side client.

2. A remote maintenance system for a semiconductor manufacturing apparatus, according to claim 1, wherein:
said maintenance information includes one type or a plurality of types of information selected from an information group constituted of information indicating the factors that cause abnormalities and corresponding corrective measures with regard to said semiconductor manufacturing apparatus, information indicating normal values of various parameters, information indicating the abnormality history, information indicating the part replacement history, part inventory information and information indicating maintenance personnel schedules.

3. A remote maintenance system for a semiconductor manufacturing apparatus, according to claim 1, wherein:
said status information includes operating state information and apparatus information with regard to said semiconductor manufacturing apparatus.

4. A remote maintenance system for a semiconductor manufacturing apparatus, according to claim 3, wherein:
said judgment unit judges that an abnormality has occurred based upon the operating state information if the ratio of unscheduled downtime of said semiconductor manufacturing apparatus exceeds a predetermined ratio, if the length of unscheduled downtime of said semiconductor manufacturing apparatus exceeds a predetermined length of time or if the number of times that said semiconductor manufacturing apparatus has experienced unscheduled downtime within a specific period of time exceeds a predetermined value.

5. A remote maintenance system for a semiconductor manufacturing apparatus, according to claim 3, wherein:
said judgment unit judges based upon said apparatus information that a semi-abnormality has occurred if said semiconductor manufacturing apparatus is in a state that does not induce a process down immediately but may lead to a process down as a long period of time elapses.

6. A remote maintenance system for a semiconductor manufacturing apparatus, according to claim 3, wherein:
if said semiconductor manufacturing apparatus is judged to have manifested an abnormality or a semi-abnormality, said judgment unit infers a probable cause of the abnormality or the semi-abnormality by comparing said apparatus information obtained immediately before or after abnormality or the semi-abnormality is detected and said maintenance information.

7. A remote maintenance system for a semiconductor manufacturing apparatus, according to claim 6, wherein:
said apparatus information used to infer the probable cause of the abnormality or the semi-abnormality includes one type or a plurality of types of log information selected from a log group constituted of a process log, a trace log and a machine log.

8. A remote maintenance system for a semiconductor manufacturing apparatus, according to claim 6, wherein:
if a plurality of probable causes of the abnormality or the semi-abnormality are inferred, the frequency with which an abnormality has been attributed to each cause is referenced.

9. A remote maintenance system for a semiconductor manufacturing apparatus, according to claim 6, wherein:
said part inventory information is referenced if the probable cause of the abnormality or the semi-abnormality that having been inferred indicates that a part needs to be replaced.

10. A remote maintenance system for a semiconductor manufacturing apparatus, according to claim 9, wherein:
if said part inventory information having been referenced indicates that the quantity of the part in stock is smaller than a predetermined inventory quantity, automatic order processing for automatically placing an order for the part is executed.

11. A factory-side client in a remote maintenance system for a semiconductor manufacturing apparatus, operating at a factory where at least one semiconductor manufacturing apparatus is installed, comprising:
a data collection unit that collects status information with regard to said semiconductor manufacturing apparatus; and
a transmission/reception unit that transmits said status information having been collected to a vendor-side server belonging to a manager who executes maintenance management for said semiconductor manufacturing apparatus via a network enabling bidirectional communication and receives information related to a judgment on an abnormality or a semi-abnormality executed by said vendor-side server based upon said status information and maintenance information stored at said vendor-side server.

12. A factory-side client in a remote maintenance system for a semiconductor manufacturing apparatus according to claim 11, wherein:
said status information includes operating state information and apparatus information with regard to said semiconductor manufacturing apparatus.

13. A factory-side client in a remote maintenance system for a semiconductor manufacturing apparatus according to claim 12, wherein:
a judgment is made based upon the operating state information that an abnormality has occurred if the ratio of unscheduled downtime of said semiconductor manufacturing apparatus exceeds a predetermined ratio, if the length of unscheduled downtime of said semiconductor manufacturing apparatus exceeds a predetermined length of time or if the number of times said semiconductor manufacturing apparatus has experienced unscheduled downtime within a specific length of time exceeds a predetermined value.

14. A factory-side client in a remote maintenance system for a semiconductor manufacturing apparatus according to claim 12, wherein:
a judgment that a semi-abnormality has occurred is made based upon said apparatus information if said semiconductor manufacturing apparatus is in a state that does not immediately induce a process down but may lead to a process down as a long period of time elapses.

15. A factory-side client in a remote maintenance system for a semiconductor manufacturing apparatus according to claim 12, wherein:
a judgment on a probable cause of the abnormality or the semi-abnormality is executed based upon said apparatus information which includes one type or a plurality of types of log information selected from a log group constituted of a process log, a trace log and a machine log.

16. A computer program that enables a computer to function in conjunction with a factory-side client according to claim 11.

17. A storage medium having a computer program according to claim 16 stored therein.

18 A vendor-side server in a remote maintenance system for a semiconductor manufacturing apparatus belonging to a manager who executes maintenance management for at least one semiconductor manufacturing apparatus installed at a factory by receiving status information with regard to said semiconductor manufacturing apparatus collected at a factory-side client operating at the factory via a network enabling bidirectional communication, comprising:
a judgment unit that executes a judgment based upon said status information as to whether or not an abnormality or a semi-abnormality has occurred in said semiconductor manufacturing apparatus corresponding to said status information;
a database unit having stored therein maintenance information with regard to said semiconductor manufacturing apparatus; and
a transmission/reception unit that receives said status information from said factory-side client and transmits information or an instruction to said factory-side client.

19. A vendor-side server in a remote maintenance system for a semiconductor manufacturing apparatus according to claim 18, wherein:
said maintenance information includes one type or a plurality of types of information selected from an information group constituted of information indicating the factors causing abnormalities and the corresponding corrective measures with regard to said semiconductor manufacturing apparatus, information indicating normal values of various parameters, information indicating the abnormality history, information indicating the part replacement history, part inventory information indicating the part inventory and information indicating maintenance personnel schedules.

20. A vendor-side server in a remote maintenance system for a semiconductor manufacturing apparatus according to claim 18, wherein:
said status information includes operating state information and apparatus information with regard to said semiconductor manufacturing apparatus.

21. A vendor-side server in a remote maintenance system for a semiconductor manufacturing apparatus according to claim 20, wherein:
said judgment unit judges that an abnormality has occurred based upon the operating state information if the ratio of unscheduled downtime of said semiconductor manufacturing apparatus exceeds a predetermined ratio, if the length of unscheduled downtime of said semiconductor manufacturing apparatus exceeds a predetermined length of time or if the number of times that said semiconductor manufacturing apparatus has experienced unscheduled downtime within a specific period of time exceeds a predetermined value.

22. A vendor-side server in a remote maintenance system for a semiconductor manufacturing apparatus according to claim 20, wherein:
said judgment unit judges based upon said apparatus information that a semi-abnormality has occurred if said semiconductor manufacturing apparatus is in a state that does not induce a process down immediately but may lead to a process down as a long period of time elapses.

23. A vendor-side server in a remote maintenance system for a semiconductor manufacturing apparatus according to claim 20, wherein:
if said semiconductor manufacturing apparatus is judged to have manifested an abnormality or a semi-abnormality, said judgment unit infers a probable cause of the abnormality or the semi-abnormality by comparing said apparatus information obtained immediately before or after abnormality or the semi-abnormality is detected and said maintenance information.

24. A vendor-side server in a remote maintenance system for a semiconductor manufacturing apparatus according to claim 23, wherein:
said apparatus information used to infer the probable cause of the abnormality or the semi-abnormality includes one type or a plurality of types of log information selected from a log group constituted of a process log, a trace log and a machine log.

25. A vendor-side server in a remote maintenance system for a semiconductor manufacturing apparatus according to claim 23, wherein:
if a plurality of probable causes of the abnormality or the semi-abnormality are inferred, the frequency with which an abnormality has been attributed to each cause is referenced.

26. A vendor-side server in a remote maintenance system for a semiconductor manufacturing apparatus according to claim 23, wherein:
part inventory information is referenced if the probable cause of the abnormality or semi-abnormality having been inferred indicates that a part needs to be replaced.

27. A vendor-side server in a remote maintenance system for a semiconductor manufacturing apparatus according to claim 26, wherein:
if said part inventory information having been referenced indicates that the quantity of the part in stock is smaller than a predetermined inventory quantity, automatic order processing for automatically placing an order for the part is executed.

28. A computer program that enables a computer to function as a vendor-side server according to claim 18.

29. A storage medium having a computer program according to claim 28 stored therein.

30. A method for executing remote maintenance for a semiconductor manufacturing apparatus, in conjunction with:
a factory-side client operating at a factory where at least one semiconductor manufacturing apparatus is installed:
a vendor-side server belonging to a manager who executes maintenance management for said semiconductor manufacturing apparatus; and
a network that connects said factory-side client and said vendor-side server with each other so as to enable bidirectional communication, wherein:
said factory-side client collects status information with regard to said semiconductor manufacturing apparatus and transmits said status information having been collected to said vendor-side server via said network; and
the vendor-side server executes a judgment based upon said status information and maintenance information with regard to said semiconductor manufacturing apparatus as to whether or not an abnormality or a semi-abnormality has occurred in said semiconductor manufacturing apparatus corresponding to said status information and said maintenance information and transmits information reflecting the results of the judgment to said factory-side client.

31. A method for executing remote maintenance for a semiconductor manufacturing apparatus, according to claim 30, wherein:
said status information includes operating state information and apparatus information with regard to said semiconductor manufacturing apparatus.

32. A method for executing remote maintenance for a semiconductor manufacturing apparatus, according to claim 31, wherein:
if said semiconductor manufacturing apparatus is judged to have manifested an abnormality or a semi-abnormality, a probable cause of the abnormality or the semi-abnormality is inferred by comparing said apparatus information obtained immediately before or after the abnormality or the semi-abnormality is detected and said maintenance information.

33. A method for executing remote maintenance for a semiconductor manufacturing apparatus, according to claim 31, wherein:
a judgment that an abnormality has occurred is made based upon the operating state information if the ratio of unscheduled downtime of said semiconductor manufacturing apparatus exceeds a predetermined ratio, if the length of unscheduled downtime of said semiconductor manufacturing apparatus exceeds a predetermined length of time or if the number of times said semiconductor manufacturing apparatus has experienced unscheduled downtime within a specific length of time exceeds a predetermined value.

34. A method for executing remote maintenance for a semiconductor manufacturing apparatus, according to claim 33, wherein:
if said semiconductor manufacturing apparatus is judged to have manifested an abnormality or a semi-abnormality, a probable cause of the abnormality or the semi-abnormality in inferred by comparing said apparatus information obtained immediately before or after the abnormality or the semi-abnormality is detected and said maintenance information.

35. A method for executing remote maintenance for a semiconductor manufacturing apparatus, according to claim 31, wherein:
a judgment that a semi-abnormality has occurred is made based upon said apparatus information if said semiconductor manufacturing apparatus is in a state that does not immediately induce a process down but may lead to a process down as a long period of time elapses.

36. A method for executing remote maintenance for a semiconductor manufacturing apparatus, according to claim 32, wherein:
part inventory information is referenced if the probable cause of the abnormality or the semi-abnormality having been inferred indicates that a part needs to be replaced.

37. A method for executing remote maintenance for a semiconductor manufacturing apparatus, according to claim 36, wherein:
if said part inventory information having been referenced indicates that the quantity of the part in stock is smaller than a predetermined inventory quantity, automatic order processing for automatically placing an order for the part is executed.

38. A method for executing remote maintenance for a semiconductor manufacturing apparatus, in conjunction with:
a customer-side server that manages a semiconductor manufacturing apparatus installed in a factory; and
a management-side server that is connected with said customer-side server via a network enabling bidirectional communication and manages said customer-side server, wherein:
said customer-side server collects apparatus information that includes operating state information and failure information with regard to said semiconductor manufacturing apparatus installed at said factory and maintenance state information indicating the state of maintenance conducted on said semiconductor manufacturing apparatus at the factory, and transmits said apparatus information having been collected to said management-side server; and
said management-side server ascertains the operating state and the failure state of said semiconductor manufacturing apparatus and the state of the maintenance conducted on said semiconductor manufacturing apparatus at a factory based upon said apparatus information, selects an optimal corrective measures from corrective measures stored in a database and transmits information indicating the selected corrective measure to said customer-side server.

39. A method for executing remote maintenance for a semiconductor manufacturing apparatus according to claim 38, wherein:
said management-side server judges based upon the maintenance state as to whether not said semiconductor manufacturing apparatus has been handled without error at the factory and, if there has been an error in handling said semiconductor manufacturing apparatus, said management-side server transmits information to said customer-side server indicating remedial measures to be taken to remedy the error.
